(19) United States
(12) Patent Application Publication
(10) Pub. No.: US 2026/0001349 A1
(43) Pub. Date: Jan. 1, 2026

(54) PRINTING DEVICE AND PRINTING METHOD

(71) Applicant: Shenzhen Anker Smart Technology Co., Ltd., Shenzhen (CN)

(72) Inventors: Xiaokang Yang, Shenzhen (CN); Wenwu Zeng, Shenzhen (CN)

(21) Appl. No.: 19/254,697

(22) Filed: Jun. 30, 2025

(30) Foreign Application Priority Data
Jun. 28, 2024 (CN) 202410866015.X

(51) Int. Cl. B41J 3/407; B41J 25/308; G01B 11/02

(52) U.S. Cl. CPC B41J 3/40731; B41J 25/3082; G01B 11/026

(57) ABSTRACT

Disclosed are a printing device and a printing method. The printing device may include a frame, and a mounting assembly, a printing assembly and a height measuring assembly provided on the frame. The mounting assembly may include a mounting platform with a mounting surface configured to mount an object to be printed, in which the mounting surface may have a mounting direction parallel to the mounting surface, and the mounting platform may be operable to reciprocate in a first direction perpendicular to the mounting surface; a printing assembly may include a print head located at a side of the mounting platform with the mounting surface, and a jet of the print head faces the mounting surface; and a height measuring assembly may include at least one group of laser through-beam sensors.

### CROSS-REFERENCE TO RELATED APPLICATIONS

This application claims priority to CN Application 202410866015.X, filed on Jun. 28, 2024. The entire content of the prior application is incorporated herein by reference.

### FIELD

The present disclosure relates to the technical field of ink-jet printing, in particular to a printing device and a printing method.

### BACKGROUND

A UV printer (Ultraviolet Printer, also known as ultraviolet printing machine or varnish curing printer) is a non-contact ink-jet printer that does not contact with an object. During the printing process, a print head precisely ejects liquid UV ink onto a surface of an object to be printed, such as paper, fabric, leather, metal, glass, plastic, and/or wood, and then irradiates the surface with ultraviolet, instantly drying and curing the UV ink on the surface, and realizing ultraviolet curing printing. Because the print head does not physically contact the object to be printed during operation, it is necessary to adjust a distance between the surface of the object and the print head to ensure printing quality and to prevent potential collisions, thereby protecting the print head.

### SUMMARY

In a first aspect, an example of the disclosure provides a printing device capable of precisely adjusting the distance between the print head and the highest point of the object to be printed, which helps prevent the object from colliding with the print head, thereby protecting the print head and ensuring the printing quality. The printing device may include a frame, and a mounting assembly, a printing assembly and a height measuring assembly provided on the frame. The mounting assembly may include a mounting platform with a mounting surface configured to mount an object to be printed, in which the mounting surface has a mounting direction parallel to the mounting surface, and the mounting platform is able to reciprocate in a first direction perpendicular to the mounting surface; a printing assembly may include a print head located at a side of the mounting platform with the mounting surface, and a jet of the print head faces the mounting surface; and a height measuring assembly may include at least one group of laser through-beam sensors, laser through beams emitted by the laser through-beam sensors are parallel to the mounting surface, and the laser through-beam sensors are located at a side of the print head close to the mounting platform in the first direction; the laser through beams emitted by at least one group of the laser through-beam sensors are disposed obliquely with respect to the mounting direction.

In a second aspect, an example of the disclosure provides a printing method applied to the printing device according to the first aspect. The printing method may include: controlling the mounting platform on which an object to be printed is placed to move close to the print head in the first direction; acquiring a first distance between a trigger position of the mounting platform and an initial position of the mounting platform in the first direction in a case where the object to be printed triggers measurement of the height measuring assembly; and controlling the printing assembly to print the object to be printed according to the first distance.

### BRIEF DESCRIPTION OF THE DRAWINGS

FIG. 1 is a front view of a printing device according to some examples of the present disclosure.

FIG. 2 is a left view of a printing device according to some examples of the present disclosure.

FIG. 3 is a right view of a printing device according to some examples of the present disclosure.

FIG. 4 is a perspective view of a printing assembly and a height measuring assembly according to some examples of the present disclosure.

FIG. 5 is a front view of a printing assembly and a height measuring assembly according to some examples of the present disclosure.

FIG. 6 is a front view of a height measuring assembly according to some examples of the present disclosure.

FIG. 7 is a top view of a height measuring assembly according to some examples of the present disclosure.

FIG. 8 is a perspective view of an adjusting structure according to some examples of the present disclosure.

FIG. 9 is a front view of an adjusting structure according to some examples of the present disclosure.

FIG. 10 is a top view of an adjusting structure according to some examples of the present disclosure.

FIG. 11 is a flowchart of a printing method according to some examples of the present disclosure.

### REFERENCE NUMERALS

100. Printing Device; 10. Mounting Assembly; 11. Mounting Platform; 111. Mounting Surface; 12. First Moving Assembly; 13. Second Moving Assembly; 20. Printing Assembly; 21. Third Moving Assembly; 30. Height Measuring Assembly; 31. Laser Through-Beam Sensor; 310. Laser Through Beam; 311. Sensor Emitting End; 312. Sensor Receiving End; 313. Adjusting Structure; 3131. First Adjusting Unit; 31311. First Adjusting Base; 31312. First Adjusting Shaft; 31313. First Elastic Member; 31314. First Adjusting Set Screw; 3132. Second Adjusting Unit; 31321. Second Adjusting Base; 31322. Second Adjusting Shaft; 31323. Second Elastic Member; 31324. Second Adjusting Set Screw; 40. Frame.

### DETAILED DESCRIPTION

In order to make the above objects, features and advantages of the present disclosure more obvious and easier to understand, specific examples of the present disclosure will be described in detail with reference to the drawings. Numerous specific details are set forth in the following description to thoroughly understand the present disclosure. However, the present disclosure can be implemented in many other ways different from those described herein, similar improvements can be made by those skilled in the art without departing from the spirit of the present disclosure, and thus the present disclosure is not limited by specific examples to be disclosed below.

In description of the disclosure, it should be understood that orientation or position relationships indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, “circumferential”, and the like are based on the orientation or position relationships shown in the drawings, which are only for the convenience of describing the disclosure and simplifying the description, and do not indicate or imply that the referred device or element must have a specific orientation and be constructed and operated in a specific orientation, and thus cannot be understood as a limit of the disclosure.

In addition, the terms “first”, “second” and “third” herein are used for a descriptive purpose only and are not to be construed as indicating or implying the relative importance or implicitly indicating the number of indicated technical features. Thus, features defined with “first” and “second” may explicitly or implicitly include at least one of such features. In the description of the present disclosure, “a plurality of” means at least two, for example, two, three, and so on, unless otherwise explicitly and specifically defined herein.

In the present disclosure, terms such as “mount”, “communicate”, “connect”, and “fix” should be understood broadly unless expressly specified or defined. For example, the terms may refer to fixed connection, detachable connection, or integration; may refer to mechanical connection or electrical connection; may refer to direct connection, indirect connection via an intermediary, or internal communication or interaction relationship between two elements, unless expressly defined. Specific meanings of the above terms in the present disclosure may be understood by those of ordinary skill in the art in light of specific circumstances.

In the present disclosure, unless otherwise explicitly specified and defined, if a first feature is described as “above” or “below” a second feature, it may mean that the first and second features are in direct contact or in indirect contact through an intermediary. Furthermore, the first feature being “above”, “upon” and “on” the second feature may be the first feature being directly above or obliquely above the second feature, or simply mean that the first feature is higher than the second feature in the horizontal height. Furthermore, the first feature being “below”, “beneath” and “under” the second feature may be the first feature being directly below or obliquely below the second feature, or simply mean that the first feature is lower than the second feature in the horizontal height.

It should be noted that if an element is referred to as “fixed to” or “disposed on” another element, it may be directly on the other element or a middle element may be present. If an element is considered to be “connected” to another element, it may be directly connected to the other element or a middle element may be present. If present, the terms “vertical”, “horizontal”, “upper”, “lower”, “left”, “right” and similar expressions used herein are for the purpose of description only and are not intended to be the only examples.

In a printing process of a UV printer, a print head has no physical contact with the object to be printed, and the print head ejects UV ink onto the object to be printed to form a pattern, and a UV lamp emits ultraviolet light to irradiate the pattern on the object to be printed, so that the pattern can be quickly dried and cured. There may be an optimal printing distance between the print head and the object to be printed, for example, 1 mm to 3 mm. Therefore, it may be necessary to adjust a distance between a surface of the object to be printed and the print head before performing UV ink ejecting on the object to be printed, or after replacing the object to be printed with one of a different height, and then move the print head to perform printing. During the printing process, it may be necessary to prevent the object to be printed from colliding with the print head and ensure safe operations of the print head.

In the related art, the distance between the print head and the object placed in the UV printer is typically judged by visual observation. However, the conventional approach makes it difficult to accurately determine the distance between the object and the print head, and manual adjustment is often required. As a result, the user experience is poor.

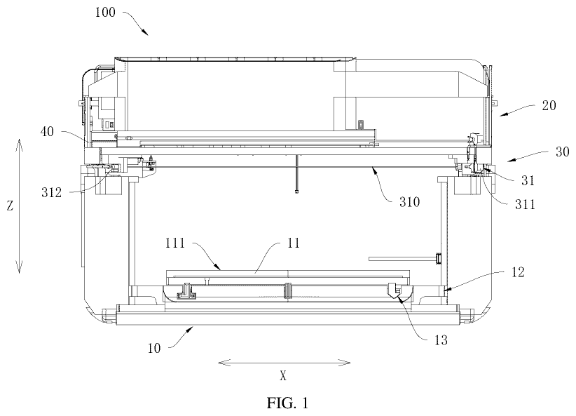

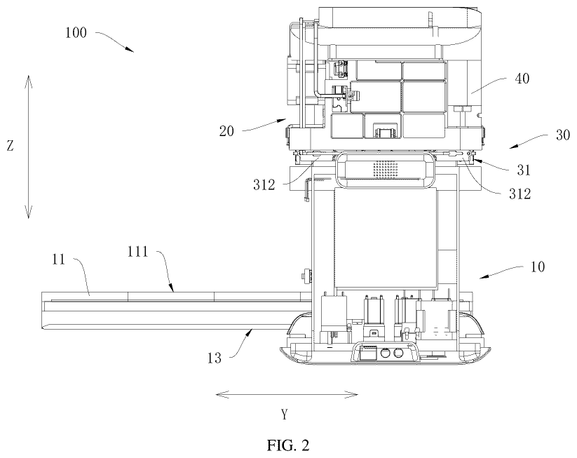

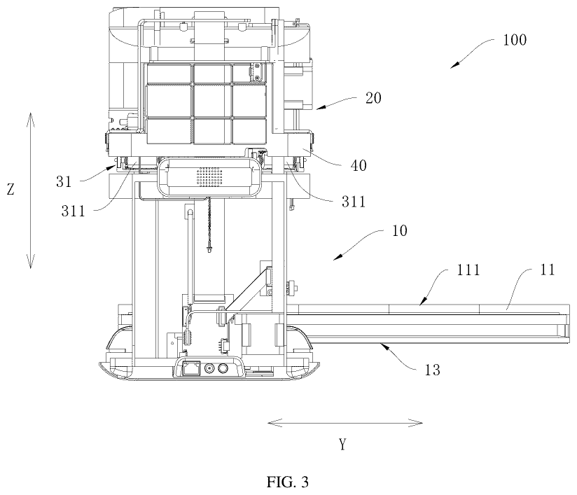

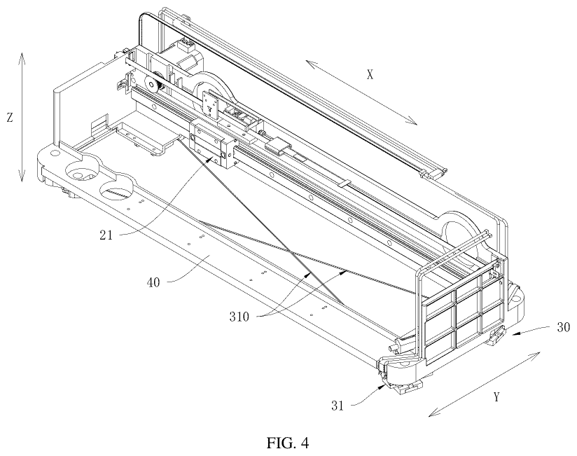

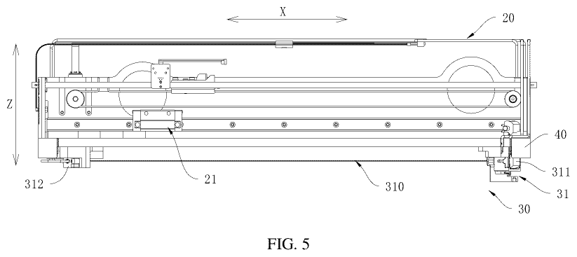

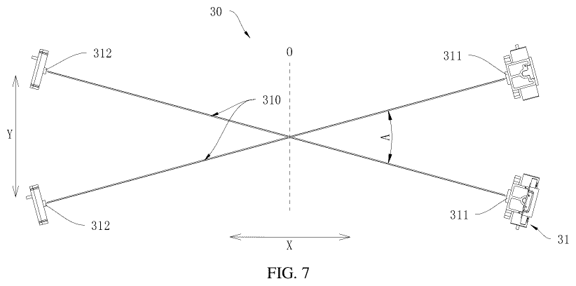

As shown in FIGS. 1 to 7, Z direction is a first direction, Y direction is a second direction, X direction is a third direction, and X direction, Y direction and Z direction are perpendicular to each other. Referring to FIGS. 1 to 3, a printing device 100 is provided in an example of the present disclosure. The printing device 100 may include a frame 40, and a mounting assembly 10, a printing assembly 20 and a height measuring assembly 30 provided on the frame 40. The mounting assembly 10 may include a mounting platform 11 with a mounting surface 111 configured to mount an object to be printed, and the mounting surface 111 has a mounting direction parallel to the mounting surface 111, and the mounting platform 11 can reciprocate in the first direction perpendicular to the mounting surface 111. The printing assembly 20 may include a print head (not shown) which is located at a side of the mounting platform 11 with the mounting surface 111, and a jet of the print head faces the mounting surface 111. The height measuring assembly 30 may include at least one group of laser through-beam sensors 31. Laser through beams 310 emitted by the laser through-beam sensors 31 are parallel to the mounting surface 111, and in the first direction, the laser through-beam sensors 31 are located at a side of the print head close to the mounting platform 11. Further referring to FIGS. 4 and 7, laser through beams 310 emitted by at least one group of the laser through-beam sensors 31 may be disposed obliquely with respect to the mounting direction.

A specific structure of the mounting platform 11 is not limited, as long as the mounting platform 11 has the mounting surface 111 on which an object to be printed can be mounted. For example, the mounting platform 11 can be a mounting plate. Mounting the object to be printed can be that the object to be printed is placed on the mounting surface 111, supported by the mounting surface 111, and then limited by a limiting structure. In case, for example, the mounting surface 111 can be parallel to a horizontal plane; or the object to be printed can be fixed on the mounting platform 11 by an adhesive, jig or the like, so that the object to be printed is not easy to move or fall off. For example, the mounting surface 111 can be inclined or vertical relative to the horizontal plane. A mounting mode is not specifically limited here. The mounting direction of the mounting surface 111 may refer to a mounting direction of the object to be printed when the object to be printed is mounted on the mounting surface 111 in design of the mounting surface 111. When the object to be printed is mounted on the mounting surface 111 in the designed mounting direction, a printed pattern without direction inclination can be printed on the object to be printed. The designed mounting direction can be any direction parallel to the mounting surface 111, and a projection of the mounting direction on the mounting surface 111 can be any direction on the mounting surface 111. For example, as shown in FIG. 7, the mounting direction can be a direction of a central axis O of the mounting surface 111. The mounting platform 11 reciprocates in the first direction, which can drive the object to be printed mounted on the mounting surface 111 to move synchronously, thus changing a position of the object to be printed in the first direction. The first direction is perpendicular to the mounting surface 111. For example, when the mounting surface 111 is parallel to the horizontal plane, the first direction may be a vertical direction, and in this case, the mounting platform 11 moves up and down in the first direction to drive the object to be printed to move up and down.

In the first direction, the print head may be located at the side of the mounting platform 11 with the mounting surface 111. For example, when the first direction is the vertical direction, the print head is located above the mounting platform 11. The jet of the print head faces the mounting surface 111, so that when an object to be printed is mounted on the mounting surface 111, the jet of the print head faces the object to be printed. The mounting platform 11 reciprocates in the first direction, which can drive the object to be printed to move close to or away from the print head, so as to adjust the distance between the object to be printed and the print head. The print head is configured to jet liquid ink onto the object to be printed such as paper, fabric, leather, plastic, metal, glass, and/or wood, which is not limited herein.

The height measuring assembly 30 may be provided with a laser through-beam sensor 31 which can emit and receive laser through beams 310; and can measure a height of the object to be printed mounted on the mounting surface 111. The height of the object to be printed may refer to a distance between a highest point of the object to be printed farthest away from the mounting surface 111 and the mounting surface 111 in the first direction when the object to be printed is mounted on the mounting surface 111. The laser through-beam sensor 31 does not directly measure the height of the object to be printed itself, but is mounted at a position of known distances from a position of the print head and an initial position of the mounting platform 11 in the first direction, so that the laser through beam 310 is parallel to the mounting surface 111 and is located at a side of the print head close to the mounting platform 11. In some examples, the laser through-beam sensor 31 may protrude from a side wall of the printing assemble 20. The initial position of the mounting platform 11 may refer to a position of the mounting platform 11 after the object to be printed is mounted on the mounting surface 111 and before the mounting platform 11 drives the object to be printed to move in the first direction. For example, the initial position of the mounting platform 11 may indicate that the mounting platform 11 moves in the first direction to a position where the mounting surface 111 is farthest away from the print head. In a process where the mounting platform 11 drives the object to be printed to move close to the print head in the first direction, when the object to be printed passes a plane position where the laser through beam 310 is located, the laser through beam 310 may be blocked by the object to be printed. At this time, the laser through-beam sensor 31 cannot receive the laser through beam 310, which triggers a detection signal, indicating that the highest point of the object to be printed beyond a plane position where the laser through beam 310 of the laser through-beam sensor 31 is located. On the contrary, the laser through beam 310 is not blocked, indicating that the highest point of the object to be printed does not reach the plane position where the laser through beam 310 of the laser through-beam sensor 31 is located, thus determining a position to which the mounting platform 11 moves when the object to be printed triggers the detection signal, e.g., a trigger position of the mounting platform 11. Since the initial position of the mounting platform 11 and the mounting position of the laser through-beam sensor 31 in the first direction are both known, a distance between the highest point of the object to be printed and the mounting surface 111 can be calculated, that is, the height of the object to be printed can be measured.

A height measuring function of the height measuring assembly 30 may be realized by the laser through-beam sensor 31. There are at least one group of laser through-beam sensors 31, for example, one group, two groups, three groups, four groups, five groups of laser through-beam sensors, which is not limited herein. Further, the laser through beam 310 emitted by the at least one group of laser through-beam sensors 31 may be set obliquely with respect to the mounting direction of the mounting surface 111, which indicates that a projection of the laser through beam 310 emitted by the at least one group of laser through-beam sensors 31 on the mounting surface 111 is not parallel to and not perpendicular to the mounting direction of the mounting surface 111. In this way, a measurement range of the height measuring assembly 30 can be greater, and meanwhile, the laser through beam 310 can be incident on the surface of the object to be printed at an oblique angle. When the object to be printed is a transparent object, the laser through beam 310 is deflected by a certain distance after being refracted by the transparent object. The distance will cause the laser through-beam sensor 31 not to receive the laser through beam 310, which can trigger a detection signal. Thus, the height measuring assembly 30 can identify the transparent object to be printed and measure a height of the transparent object to be printed.

The printing device 100 can be applied to printing of objects to be printed with different heights and printing of transparent objects to be printed, with a wider application range. The height of the object to be printed is measured and determined by the height measuring assembly 30, and the height of the object to be printed is equal to a distance between the mounting position of the laser through-beam sensor 31 and the trigger position of the mounting platform 11. Since a distance between the mounting position of the laser through-beam sensor 31 and the position of the print head in the first direction is known, a distance between the print head and the highest point of the object to be printed can be calculated and determined according to the height of the object to be printed, so that the distance between the print head and the highest point of the object to be printed can be adjusted to be an optimal printing distance, which prepares for the subsequent printing, facilitates improving printing quality, and ensures printing effect. The distance between the highest point of the object to be printed and the print head can be accurately adjusted, which facilitates preventing the risk of colliding with the print head caused by an excessively large height of the object to be printed, protects the print head, and ensures safe operations of the print head. In some examples, the optimal printing distance can range from 1 mm to 3 mm, such as 1.5 mm, 2 mm or 2.5 mm.

The laser through-beam sensor 31 can also be configured to directly determine a first distance L1 when the mounting platform 11 moves to the trigger position in the first direction, and the first distance L1 is a moving distance between the trigger position of the mounting platform 11 and the initial position of the mounting platform 11. At this time, according to a known second distance L2 between the mounting position of the laser through-beam sensor 31 and the position of the print head in the first direction and a reserved distance between the highest point of the object to be printed and the print head such as 3 mm, a distance by which the mounting platform 11 needs to move of L1+(L2−2 mm) can be calculated. In this way, a distance between the highest point of the object to be printed and the print head can be adjusted without calculating an actual height of the object to be printed.

The laser through beam 310 emitted by the at least one group of laser through-beam sensors 31 of the height measuring assembly 30 may be inclined relative to the mounting direction of the mounting surface 111, so that the printing device 100 of an example of the present disclosure can cover a larger measurement area, which facilitates more accurate measurement of the height of the object to be printed and can identify the transparent object to be printed, thereby measuring the height of the transparent object to be printed. This approach may facilitate accurate determination of the distance between the highest point of the transparent object to be printed and the print head, thereby accurately adjusting the distance between the print head and the highest point of the object to be printed, so as to prepare for the subsequent printing, facilitate improving the printing quality. The examples of the present disclosure may further reduce the risk of collision with the print head caused by the excessively large height of the object to be printed, protecting the print head, ensuring the safe operations of the print head, and reducing the manual operation. Moreover, the printing device 100 can be used for printing objects with different heights and the transparent object to be printed, which has a wide range of applications and brings better printing experience to users.

In some examples, the printing device 100 further may include a control assembly or a controller (not shown), which is electrically connected or coupled with both the printing assembly 20 and the height measuring assembly 30. For example, the control assembly may include a control circuit board. In some examples, the control assembly may be separate from the printing device 100. After obtaining the height of the object to be printed, the control assembly can automatically move the object to be printed on the mounting surface 111 to a position where the highest point of the object to be printed is 2 mm away from the print head, so as to prepare for the subsequent printing.

In some examples, referring to FIG. 4 and FIG. 7, there may be at least two groups of laser through-beam sensors 31, and the laser through beams 310 emitted by the at least two groups of laser through-beam sensors 31 intersect. Since two or more groups of laser through-beam sensors 31 are provided and the laser through beams 310 emitted by the at least two groups of laser through-beam sensors 31 intersect inside the printing device 100, the laser through beams 310 emitted by multiple groups of laser through-beam sensors 31 can cover an entire printing area of the printing assembly 20, a formed through beam plane can cover a larger measuring area, and the measurement range of the height measuring assembly 30 is greater, so that the height of the object to be printed can be measured more accurately, and better printing experience can be provided for the users.

In some examples, an included angle A between two intersecting laser through beams 310 may be less than 90 degrees and greater than or equal to 30 degrees, which facilitates reducing an occupied space when the laser through-beam sensor 31 is arranged, thereby reducing the volume of the printing device 100, facilitating accurate determination of the distance between the transparent object to be printed and the print head, and improving user experience.

In some examples, referring to FIGS. 1 to 3, the mounting assembly 10 further may include a first moving assembly 12 and a second moving assembly 13. The mounting platform 11 is disposed on the second moving assembly 13, and the second moving assembly 13 is disposed on the first moving assembly 12. The first moving assembly 12 can drive the second moving assembly 13 and the mounting platform 11 to reciprocate in the first direction; the second moving assembly 13 can drive the mounting platform 11 to reciprocate in the second direction; the second direction and the first direction are perpendicular to each other.

The first moving assembly 12 and the second moving assembly 13 can be a linear motion pair, for example, the linear motion pair may be a ball and a screw, a worm and a worm gear, a gear and a rack, a slide rail and a slider, or the like, which is not limited herein. In the printing process, the object to be printed is mounted on the mounting platform 11, the first moving assembly 12 drives the mounting platform 11 to reciprocate in the first direction, and the mounting platform 11 drives the object to be printed to move close to or away from the print head, so as to adjust the distance between the highest point of the object to be printed and the print head. After the distance adjustment is completed, the second moving assembly 13 drives the mounting platform 11 to reciprocate in the second direction, and the mounting platform 11 drives the object to be printed to move in the second direction. At the same time, the print head prints the object to be printed, realizing printing of different printed image areas of the object to be printed in the second direction. In this way, the printing device 100 can have a larger printing area, which facilitates printing of a larger object to be printed, and the print head does not need to move in the second direction, so that the printing is more stable, which facilitates improving the printing quality and provides better printing experience for users.

In some examples, the printing device 100 can be an ink-jet printer, the mounting platform 11 can be a flatbed, and the mounting surface 111 can be a plane. The second moving assembly 13 drives the mounting platform 11 to move in the second direction. The printing assembly 20 further may include a third moving assembly 21 which may include a guide rail beam and a slider. An extending direction of the guide rail beam is parallel to the third direction, the slider is slidably connected to the guide rail beam, the print head is mounted on the slider, and the slider can drive the print head to move along the guide rail beam, so that the print head can move in the third direction. The third direction is perpendicular to the first direction and the second direction. In a process of ink-jet printing, the guide rail beam does not move, the object to be printed is fixed on the mounting surface 111 of the mounting platform 11 below the guide rail beam, the print head moves back and forth along the guide rail beam and jets ink drops on the object to be printed to form pictures and texts when passing a printing image area of the object to be printed. Thereafter, a curing device performs ultraviolet lamp irradiation treatment on the ink drops on the object to be printed, so that the ink drops are cured and 2D curing printing is realized.

In some examples, the printing device 100 may be a UV flatbed printer, and the ink may be UV ink. The printing device 100 further may include a curing assembly which may include a UV lamp, and the UV ink jetted on the object to be printed is instantly dried and cured by irradiation with the UV lamp to realize UV curing printing.

In some examples, the printing device 100 f may further include an image acquisition assembly (not shown), which is disposed at a side of the mounting platform 11 with the mounting surface 111.

For example, the image acquisition assembly may include a camera which can be a charge coupled device (CCD) camera. When the mounting surface 111 is parallel to the horizontal plane, the camera is located above the mounting surface 111 to acquire an image of the mounting surface 111. In some examples, the image acquisition assembly may be positioned at a center point on a top surface of the printing assembly. During use, the object to be printed is placed on the mounting surface 111 of the mounting platform 11. Firstly, an approximate position of the object to be printed on the mounting surface 111 of the mounting platform 11 is acquired by the camera; and according to the approximate position of the object to be printed, the mounting platform 11 is controlled to move to move the object to be printed within the measurement range of the height measuring assembly 30, which facilitates improving measurement accuracy and efficiency and improves the printing experience.

In some examples, referring to FIGS. 1 to 5, the third moving assembly 21 may be disposed at the top of the frame 40 and can drive the print head to reciprocate in the third direction. The first moving assembly 12 is disposed on the frame 40, the second moving assembly 13 is disposed on the first moving assembly 12, and the mounting platform 11 is disposed on the second moving assembly 13. The first moving assembly 12, the second moving assembly 13 and the mounting platform 11 are located below the print head. The second moving assembly 13 can drive the mounting platform 11 to reciprocate in the second direction, and the first moving assembly 12 can drive the second moving assembly 13 to reciprocate in the first direction.

In some examples, referring to FIGS. 1 and 6 to 8, the laser through-beam sensor 31 may include a sensor emitting end 311 and a sensor receiving end 312 which are disposed at opposite sides of the print head, the sensor emitting end 311 is configured to emit the laser through beam 310, and the sensor receiving end 312 is configured to receive the laser through beam 310. One of the sensor emitting end 311 and the sensor receiving end 312 is fixedly disposed on the frame 40, and the other of the sensor emitting end 311 and the sensor receiving end 312 is mounted on the frame 40 through an adjusting structure 313. The adjusting structure 313 is configured to adjust a posture of the sensor emitting end 311 or the sensor receiving end 312, so that the sensor emitting end 311 is aligned with the sensor receiving end 312.

For example, the sensor emitting end 311 and the sensor receiving end 312 may be disposed at opposite sides of the print head along the third direction. In the second direction, two adjacent sensor emitting ends 311 are arranged at intervals, and two adjacent sensor receiving ends 312 are arranged at intervals. The included angle A between two intersecting laser through beams 310 may refer to an included angle between two sensor emitting ends 311 or between two sensor receiving ends 312. In this way, a through beam plane formed by the laser through beams 310 emitted by multiple laser through-beam sensors 31 can cover the printing area, so that the object to be printed is located within the measurement range of the height measuring assembly 30, which facilitates measurement and printing. In some examples, the sensor emitting end 311 and the sensor receiving end 312 are disposed at the opposite sides of the mounting platform 11 along the third direction, the central axis O of the mounting surface 111 is parallel to the second direction, and the laser through beam 310 is set obliquely relative to the central axis O of the mounting surface 111 (e.g., the mounting direction of the mounting surface 111), so that the laser through beam 310 is obliquely emitted and received by the laser through-beam sensor 31 in the third direction. By disposing the sensor emitting end 311 and the sensor receiving end 312 of the laser through-beam sensor 31 at the opposite sides of the mounting platform 11, the through beam plane formed by the laser through beam 310 emitted by multiple laser through-beam sensors 31 can cover the mounting surface 111, so that the object to be printed can be located within the measurement range of the height measuring assembly 30, which facilitates reducing movement of the mounting platform 11 and improving printing efficiency.

A mounting structure of the laser through-beam sensor 31 can be that the sensor emitting end 311 is fixedly disposed and the sensor receiving end 312 is mounted on the adjusting structure 313, and a posture of the sensor receiving end 312 is adjusted through the adjusting structure 313 so that the sensor emitting end 311 is aligned with the sensor receiving end 312. Alternatively, the sensor emitting end 311 is mounted on the adjusting structure 313 while the sensor receiving end 312 is fixedly disposed, and a posture of the sensor emitting end 311 is adjusted through the adjusting structure 313 so that the sensor emitting end 311 is aligned with the sensor receiving end 312. A specific structure of the adjusting structure 313 is not limited, as long as it can be used for mounting the sensor emitting end 311 or the sensor receiving end 312 and adjusting the posture of the sensor emitting end 311 or the sensor receiving end 312. For example, the adjusting structure 313 is mounted on the frame 40, one of the sensor emitting end 311 and the sensor receiving end 312 is fixedly mounted on the frame 40, and the other of the sensor emitting end 311 and the sensor receiving end 312 is mounted on the frame 40 through the adjusting structure 313.

The adjusting structure 313 may be provided to adjust the posture of the sensor emitting end 311 or the sensor receiving end 312, so that the sensor emitting end 311 can be aligned with the sensor receiving end 312, thus realizing laser alignment, and ensuring that the sensor receiving end 312 can receive the laser through beam 310 emitted by the sensor emitting end 311 in a case where no object to be printed blocks the laser through beam 310, which facilitates improving measurement accuracy while reducing requirement for the mounting accuracy of the laser through-beam sensor 31, makes the mounting convenient, reduces user's operation, and improves use experience.

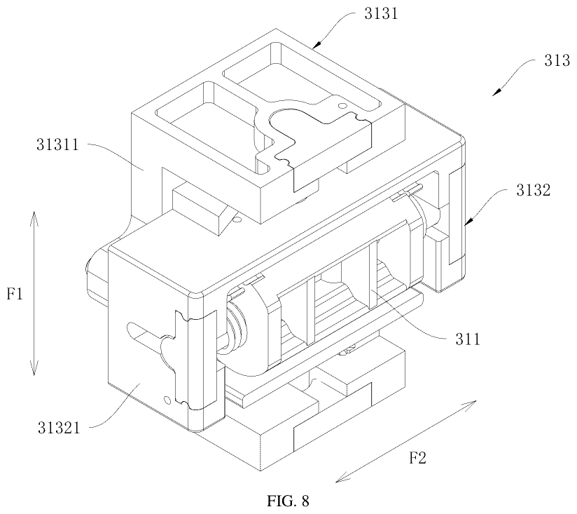

In some examples, referring to FIGS. 8 to 10, the adjustment structure 313 may include at least one of a first adjusting unit 3131 and a second adjusting unit 3132, an adjusting axis of the first adjusting unit 3131 and an adjusting axis of the second adjusting unit 3132 are perpendicular to each other, and the adjusting axis of the first adjusting unit 3131 or the adjusting axis of the second adjusting unit 3132 is parallel to the first direction.

As shown in FIGS. 8 to 10, F1 direction is a direction of the adjusting axis of the first adjusting unit 3131, F2 direction is a direction of the adjusting axis of the second adjusting unit 3132, and F1 direction and F2 direction are perpendicular to each other. For example, the adjusting structure 313 may include the first adjusting unit 3131, the sensor emitting end 311 and/or the sensor receiving end 312 is mounted on the first adjusting unit 3131, and the first adjusting unit 3131 can rotate around its own adjusting axis to adjust the posture of the sensor emitting end 311 or the sensor receiving end 312. Additionally and/or alternatively, the adjusting structure 313 may include the second adjusting unit 3132, the sensor emitting end 311 or the sensor receiving end 312 is mounted on the second adjusting unit 3132, and the second adjusting unit 3132 can rotate around its own adjusting axis to adjust the posture of the sensor emitting end 311 or the sensor receiving end 312. Additionally and/or alternatively, the adjusting structure 313 may include both the first adjusting unit 3131 and the second adjusting unit 3132, and the sensor emitting end 311 or the sensor receiving end 312 is mounted on the second adjusting unit 3132, and the second adjusting unit 3132 is mounted on the first adjusting unit 3131. The first adjusting unit 3131 can rotate around its own adjusting axis to adjust the posture of the sensor emitting end 311 or the sensor receiving end 312, and the second adjusting unit 3132 can rotate around its own adjusting axis to adjust the posture of the sensor emitting end 311 or the sensor receiving end 312, thus adjusting the posture of the sensor emitting end 311 or the sensor receiving end 312 by rotation in two directions.

For example, the adjusting axis of the first adjusting unit 3131 may be parallel to the first direction, and the adjusting axis of the second adjusting unit 3132 is perpendicular to the first direction; alternatively, the adjusting axis of the first adjusting unit 3131 is perpendicular to the first direction, and the adjusting axis of the second adjusting unit 3132 is parallel to the first direction.

In this way, the adjusting structure 313 can realize adjustment of the posture of the sensor emitting end 311 or the sensor receiving end 312 by rotation in at least one direction, which facilitates quick alignment of the sensor emitting end 311 with the sensor receiving end 312, facilitates user's operation, and improves the use experience.

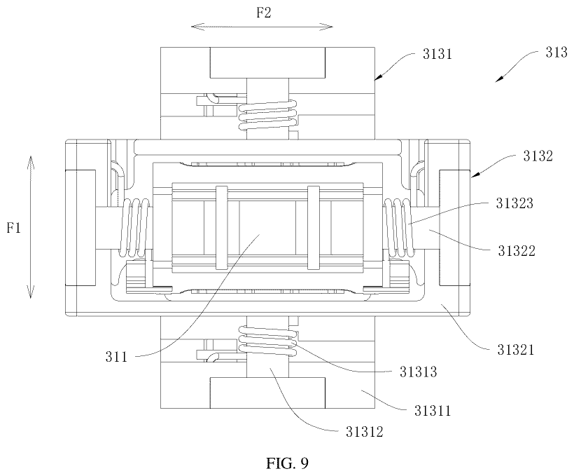

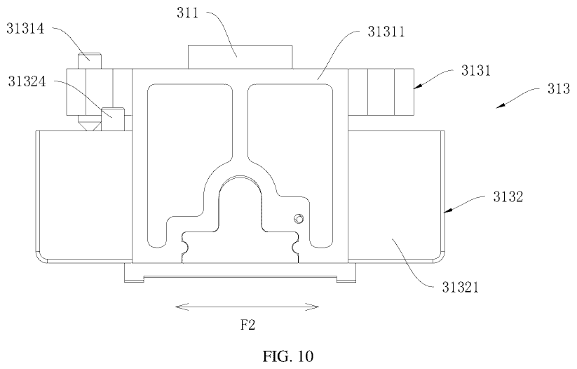

In some examples, referring to FIGS. 9 and 10, the first adjusting unit 3131 may include a first adjusting base 31311, a first adjusting shaft 31312, a first elastic member 31313 and a first adjusting set screw 31314. The first adjusting base 31311 is configured to mount the first adjusting unit 3131, for example, the first adjusting base 31311 is fixedly connected with the frame 40, thereby fixedly mounting the first adjusting unit 3131 to the frame 40. The first adjusting shaft 31312 is connected to the first adjusting base 31311, and is configured to rotatably mount a first adjusting object on the first adjusting base 31311, for example, the first adjusting object can be the second adjusting unit 3132, the sensor emitting end 311 or the sensor receiving end 312. The first adjusting set screw 31314 is connected to the first adjusting base 31311 and abuts against the first adjusting object, and the first adjusting object can be pushed to rotate around a central axis of the first adjusting shaft 31312 (that is, the adjusting axis of the first adjusting unit 3131) by turning the first adjusting set screw 31314, so that the posture of the sensor emitting end 311 or the sensor receiving end 312 can be adjusted by rotation around the adjusting axis of the first adjusting unit 3131. The first elastic member 31313 is connected between the first adjusting base 31311 and the first adjusting object, and is configured to provide a restoring force for the first adjusting object, which facilitates improving posture adjustment accuracy of the sensor emitting end 311 or the sensor receiving end 312. For example, the first elastic member 31313 may be a torsion spring which is sleeved on the first adjusting shaft 31312.

In some examples, referring to FIGS. 9 and 10, a structure of the second adjusting unit 3132 may be substantially the same as a structure of the first adjusting unit 3131. Specifically, the second adjusting unit 3132 may include a second adjusting base 31321, a second adjusting shaft 31322, a second elastic member 31323 and a second adjusting set screw 31324. The second adjusting base 31321 is configured to mount the second adjusting unit 3132, for example, the second adjusting base 31321 is connected with the first adjusting shaft 31312, so that the second adjusting unit 3132 is rotatably mounted on the first adjusting base 31311. The second adjusting shaft 31322 is connected to the second adjusting base 31321, and the second adjusting shaft 31322 is configured to rotatably mount a second adjusting object on the second adjusting base 31321, for example, the second adjusting object can be the sensor emitting end 311 or the sensor receiving end 312. The second adjusting set screw 31324 is connected to the second adjusting base 31321 and abuts against the second adjusting object, and the second adjusting object can be pushed to rotate around a central axis of the second adjusting shaft 31322 (that is, the adjusting axis of the second adjusting unit 3132) by turning the second adjusting set screw 31324, so that the posture of the sensor emitting end 311 or the sensor receiving end 312 can be adjusted by rotation around the adjusting axis of the second adjusting unit 3132. The second elastic member 31323 is connected between the second adjusting base 31321 and the second adjusting object, and is configured to provide a restoring force for the second adjusting object, which facilitates improving of posture adjustment accuracy of the sensor emitting end 311 or the sensor receiving end 312. For example, the second elastic member 31323 can be a torsion spring which is sleeved on the second adjusting shaft 31322.

In some examples, the sensor receiving end 312 may be fixedly disposed, and an adjustment mark (not shown) is provided at a fixed position of the sensor receiving end 312. For example, the adjustment mark can be a mark line. At this time, the sensor emitting end 311 is mounted on the adjusting structure 313, and the posture of the sensor emitting end 311 is adjusted by the adjusting structure 313. During an adjustment process, the laser beam emitted by the sensor emitting end 311 irradiates the adjustment mark, which can indicate a posture adjustment process of the sensor emitting end 311. The adjustment mark is used to determine whether adjustment is successful, that is, whether the sensor emitting end 311 is aligned with the sensor receiving end 312. This may facilitate improving adjustment efficiency and adjustment accuracy of the posture of the sensor transmitter 311, facilitate the user's operation, and improve the use experience.

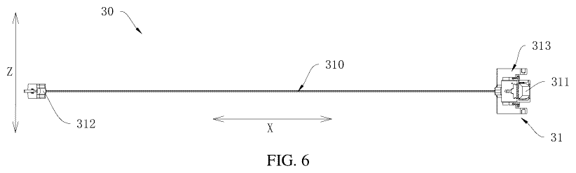

In some specific examples, referring to FIGS. 6 and 8 to 10, in the third direction, the sensor receiving end 312 may be fixedly disposed at a side of the mounting platform 11, and the sensor emitting end 311 is disposed at an opposite side of the mounting platform 11 through the adjusting structure 313. The central axis O of the mounting surface 111 is parallel to the second direction. The adjusting structure 313 may include the first adjusting unit 3131 and the second adjusting unit 3132. The first adjusting unit 3131 is mounted on the frame 40 through the first adjusting base 31311. The second adjusting base 31321 is connected to the first adjusting base 31311 through the first adjusting shaft 31312, so that the second adjusting unit 3132 is rotatably mounted on the first adjusting unit 3131. The first adjusting shaft 31312 is parallel to the first direction, that is, the adjusting axis of the first adjusting unit 3131 is parallel to the first direction. The sensor emitting end 311 is connected to the second adjusting base 31321 through the second adjusting shaft 31322, so that the sensor emitting end 311 is rotatably mounted on the second adjusting unit 3132. The second adjusting shaft 31322 is perpendicular to the first adjusting shaft 31312, that is, the adjusting axis of the second adjusting unit 3132 is perpendicular to the adjusting axis of the first adjusting unit 3131. In this way, the posture of the sensor emitting end 311 can be adjusted by rotation in two directions.

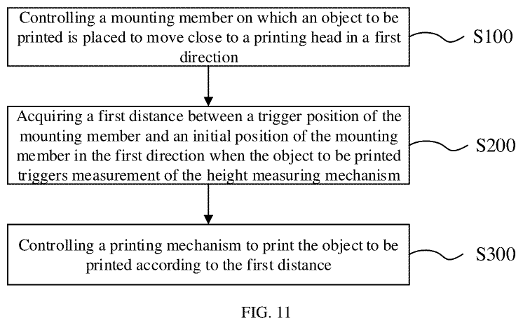

Referring to FIG. 11, FIG. 11 shows a flowchart of a printing method in some examples of the present disclosure. The printing method provided in the present disclosure may be applied to the printing device 100 provided in any of the above examples. The printing method may include following steps:
step S100: controlling a mounting platform 11 on which an object to be printed is placed to move close to a print head in a first direction;
step S200: acquiring a first distance L1 between a trigger position of the mounting platform 11 and an initial position of the mounting platform 11 in the first direction when the object to be printed triggers measurement of the height measuring assembly 30; and
step S300: controlling a printing assembly 20 to print the object to be printed according to the first distance L1.

The initial position of the mounting platform 11 may refer to a position of the mounting platform 11 before controlling the mounting platform 11 on which the object to be printed is placed to move close to the print head in the first direction. The trigger position of the mounting platform 11 may refer to a position to which the mounting platform 11 moves when the object to be printed triggers measurement of the height measuring assembly 30. A principle that the object to be printed triggers measurement of the height measuring assembly 30 is that the object to be printed is mounted on the mounting surface 111 of the mounting platform 11, in a process of the mounting platform 11 moving close to the print head in the first direction, when the object to be printed blocks the laser through beam 310 emitted by the laser through-beam sensor 31, measurement of the height measuring assembly 30 is triggered and a distance by which the mounting platform 11 moves in the first direction to the trigger position is recorded, so that the first distance L1 between the trigger position of the mounting platform 11 and the initial position of the mounting platform 11 in the first direction can be calculated. Meanwhile, since a second distance L2 between the mounting position of the laser through-beam sensor 31 of the first height-measuring assembly 30 and the position of the print head in the first direction and a third distance L3 between the mounting position of the laser through-beam sensor 31 of the first height-measuring assembly 30 and the initial position of the mounting platform 11 in the first direction are both known, so that a fourth distance L4 between the trigger position of the mounting platform 11 and the mounting position of the laser through-beam sensor 31 of the height-measuring assembly 30 in the first direction can be calculated, for example L4=L3−L1. It can be understood that the highest point of the object to be printed triggers measurement of the height measuring assembly 30, and the fourth distance L4 is equal to the distance between the trigger position of the mounting platform 11 and the highest point of the object to be printed in the first direction, that is, the height of the object to be printed. After the first distance L1 is obtained, a distance between the print head and the highest point of the object to be printed when measurement of the height measuring assembly 30 is triggered can be calculated and determined, and then the printing assembly 20 can be controlled to print the object to be printed under a condition of accurately adjusting the distance between the print head and the highest point of the object to be printed.

According to the printing method of the example of the disclosure, by triggering the height measuring assembly 30 to measure, a larger measurement area can be covered, the distance between the print head and the highest point of the object to be printed can be accurately measured, a transparent object to be printed can be identified and measured, and a distance between the highest point of the transparent object to be printed and the print head can be accurately adjusted, so that the distance between the print head and the highest point of the object to be printed can be accurately adjusted, facilitating improvement of the printing quality, ensuring the printing effect, preventing danger of collision with the print head caused by an excessively large height of the object to be printed, realizing the protection of the print head, ensuring safe operations of the print head, and reducing the manual operation. Moreover, the printing method can be used to print objects to be printed with different heights and the transparent object to be printed, which has a wide range of applications and provides better printing experience for users.

In some examples, the method may further include the following steps before controlling the mounting platform 11 on which the object to be printed is placed to move close to the print head in the first direction:
Step S11: acquiring an image of the mounting surface 111 of the mounting platform 11;
Step S12: identifying a position of the object to be printed placed on the mounting platform 11 according to the image of the mounting surface 111; and
Step S13: controlling the mounting platform 11 to move in a direction perpendicular to the first direction according to the position of the object to be printed, so that the object to be printed moves within a measurement range of the height measuring assembly 30.

An image acquisition assembly such as a camera can be adopted to acquire an image of the mounting surface 111 of the mounting platform 11. After the image of the mounting surface 111 is obtained, the object to be printed placed on the mounting platform 11 can be automatically identified by image identification, and then the mounting platform 11 is controlled to move, and the position of the object to be printed is automatically adjusted, so that the object to be printed moves within the measurement range of the height measuring assembly 30. The measurement range of the height measuring assembly 30 may refer to an area range that can block the laser through beam 310 emitted by the laser through-beam sensor 31 of the height measuring assembly 30 to trigger measurement of the height measuring assembly 30, for example, a projection range of the through beam plane formed by the laser through beam 310 of the laser through-beam sensors 31 on the mounting surface 111. For example, the mounting platform 11 can move in the second direction to drive the object to be printed mounted on the mounting surface 111 to move within the measurement range of the height measuring assembly 30.

The position of the object to be printed may be identified through image identification and the object to be printed is automatically moved within the measurement range of the height measuring assembly 30, which facilitates improvement of the measuring accuracy and efficiency, further improves the printing efficiency, facilitates reducing manual operations, and provides better printing experience for users.

In some examples, the acquiring the first distance L1 between the trigger position of the mounting platform 11 and the initial position of the mounting platform 11 in the first direction when the object to be printed triggers measurement of the height measuring assembly 30 specifically may include the following steps:
Step S201: triggering measurement of the height measuring assembly 30 and recording the initial trigger position when the laser through beam 310 emitted by at least one group of laser through-beam sensors 31 is not received;
step S202: controlling the mounting platform 11 to move in the direction perpendicular to the first direction to change a position of the object to be printed within the measurement range of the height measuring assembly 30; and after changing the position of the object to be printed every time, controlling the mounting platform 11 to reciprocate in the first direction to pass the initial trigger position to obtain a plurality of re-trigger positions where measurement of the height measuring assembly 30 is re-triggered; and
Step S203: determining the trigger position of the mounting platform 11 according to the initial trigger position and a plurality of the re-trigger positions, and calculating the first distance L1 between the trigger position of the mounting platform 11 in the first direction and the initial position of the mounting platform 11.

Since the object to be printed reciprocates up and down, back and forth, left and right at the initial trigger position, the trigger position of the mounting platform 11 in the first direction can be confirmed for a second time, which facilitates accurate finding of the highest point of the object to be printed, and a highest point of an object to be printed with a hollow structure can also be detected, thereby improving measurement accuracy, which facilitates improvement of the printing quality, has a wide range of application, and provides better printing experience for users.

In some examples, the controlling the printing assembly 20 to print the object to be printed according to the first distance L1 specifically may include following steps:
Step S301: determining a moving distance of the mounting platform 11 in the first direction according to the first distance L1 and the known second distance L2 between the mounting position of the laser through-beam sensor 31 of the height measuring assembly 30 and the position of the print head in the first direction;
Step S302: controlling the mounting platform 11 to move in the first direction according to the moving distance, so that the distance between the highest point of the object to be printed and a jet of the print head is a set distance L5; and
Step S303: controlling the printing assembly 20 to print the object to be printed.

The set distance L5 is a preset distance between the highest point of the object to be printed and the jet of the print head, for example, the set distance L5 can be 2 mm. The position of the print head may refer to a position of the jet of the print head. After the first distance L1 between the trigger position of the mounting platform 11 and the initial position of the mounting platform 11 in the first direction is obtained, the mounting platform 11 is controlled to move in the first direction according to the known second distance L2 between the mounting position of the laser through-beam sensor 31 of the height measuring assembly 30 and the position of the print head in the first direction, so as to drive the object to be printed to rise to a position where the distance between the highest point and the jet of the print head is the set distance L5, and then printing is performed. A total distance by which the object to be printed needs to move is L1+(L2−L5). The object to be printed can be printed according to graphics input by the user.

Thus, the print head can print the object to be printed with an optimal printing distance, which may facilitate improving the printing quality and ensuring the printing effect, prevents danger of collision with the print head caused by the excessively large height of the object to be printed, realizing the protection of the print head, ensuring the safe operations of the print head, and reduces the manual operation, providing better printing experience for users.

In some examples, the method may further include following steps before controlling the mounting platform 11 on which the object to be printed is placed to move close to the print head in the first direction:
Step S01: controlling the mounting platform 11 to move to the initial position of the mounting platform 11 in the first direction in a case where a first instruction is received; and
Step S02: starting printing in a case where a second instruction is received. The first instruction is a printing instruction and the second instruction is a printing confirmation instruction.

In this example, a mobile phone app (application, e.g., a mobile phone software) or PC software used in conjunction with the printing device 100 can be set. When the user needs to start printing, the first instruction to print an object can be sent through the mobile phone app or PC software, after a control panel of the printing device 100 receives the first instruction, the mounting platform 11 is moved to a farthest position away from the print head, that is, the initial position of the mounting platform 11. For example, when the mounting surface 111 is parallel to the horizontal plane, the mounting platform 11 moves to a lowest position. After placing the object to be printed on the mounting surface 111 of the mounting platform 11, the user continues to send a second instruction to confirm printing. After the control panel of the printing device 100 receives the second instruction, a top camera acquires an approximate position of the object to be printed on the mounting platform 11, so as to delimit a printing area in advance and speed up height measurement. Thereafter, the mounting platform 11 is moved in the second direction, and the object to be printed is moved below the laser through-beam sensor 31 to enter the measurement range of the height measuring assembly 30. By moving the mounting platform 11 in the first direction, the laser through beam 310 is blocked by the object to be printed, which triggers measurement of the height measuring assembly 30 and confirms that the object to be printed put in by the user can be printed, and the initial trigger position of the object to be printed is output by calculation. By moving up and down, back and forth, left and right at the initial trigger position, a specific trigger position of the mounting platform 11 is determined, for example, a hollow object can move up and down, back and forth to confirm the trigger position of the mounting platform 11 for a second time. After the trigger position of the mounting platform 11 is found, the mounting platform 11 is moved to stop the object to be printed at a position 2 mm from the print head. After the position of the object to be printed is moved in place, printing starts according to a picture set by the user.

The technical features of the above-mentioned examples can be combined arbitrarily. For brevity of description, not all possible combinations of the technical features in the above examples are described.

The examples described above represent only several examples of the present disclosure, which are described in detail but should not be construed as limitations of the scope of the disclosure. It should be noted that several variations and improvements can be made without departing from the spirit of the disclosure for those skilled in the art, all of which fall within the scope of the present disclosure. Accordingly, the scope of the present disclosure should be subject to the appended claims.

What is claimed is:

1. A printing device comprising a frame, wherein the frame comprises:
a mounting assembly comprising a mounting platform with a mounting surface configured to mount an object to be printed, wherein the mounting surface has a mounting direction parallel to the mounting surface, and the mounting platform is operable to reciprocate in a first direction perpendicular to the mounting surface;
a printing assembly comprising a print head located at a side of the mounting platform with the mounting surface, a jet of the print head facing the mounting surface; and
a height measuring assembly comprising at least one group of laser through-beam sensors, wherein laser through beams emitted by the at least one group of laser through-beam sensors are parallel to the mounting surface.

2. The printing device according to claim 1, wherein the at least one group of laser through-beam sensors are located at a side of the print head close to the mounting platform in the first direction.

3. The printing device according to claim 1, wherein the laser through beams emitted by at least one group of the laser through-beam sensors are disposed obliquely with respect to the mounting direction.

4. The printing device according to claim 1, wherein the height measuring assembly comprises at least two groups of the laser through-beam sensors, and the laser through beams emitted by the at least two groups of the laser through-beam sensors intersect.

5. The printing device according to claim 1, further comprising an image acquisition assembly disposed at a side of the mounting platform with the mounting surface.

6. The printing device according to claim 1, further comprising an image acquisition assembly disposed at a center point on a top surface of the printing assembly.

7. The printing device according to claim 1, wherein the laser through-beam sensor comprises a sensor emitting end and a sensor receiving end which are disposed at opposite sides of the print head, the sensor emitting end being configured to emit the laser through beam, and the sensor receiving end being configured to receive the laser through beam.

8. The printing device according to claim 7, wherein one of the sensor emitting end and the sensor receiving end is fixedly disposed on the frame, and the other of the sensor emitting end and the sensor receiving end is mounted on the frame through an adjusting structure, the adjusting structure being configured to adjust a posture of the sensor emitting end or the sensor receiving end so that the sensor emitting end is aligned with the sensor receiving end.

9. The printing device according to claim 8, wherein the adjusting structure comprises at least one of a first adjusting unit and a second adjusting unit, an adjusting axis of the first adjusting unit and an adjusting axis of the second adjusting unit are perpendicular to each other, and the adjusting axis of the first adjusting unit or the adjusting axis of the second adjusting unit is parallel to the first direction.

10. The printing device according to claim 1, wherein the laser through-beam sensor protrudes from a side wall of the printing assembly.

11. The printing device according to claim 1, wherein the mounting assembly further comprises a first moving assembly and a second moving assembly, the mounting platform is disposed on the second moving assembly, the second moving assembly is disposed on the first moving assembly, and the first moving assembly is operable to drive the second moving assembly and the mounting platform to reciprocate in the first direction; the second moving assembly is operable to drive the mounting platform to reciprocate in a second direction, the second direction and the first direction are perpendicular to each other.

12. The printing device according to claim 1, further comprising a controller, wherein the controller is configured to:
control the mounting platform on which the object to be printed is placed to move close to the print head in the first direction;
acquire a first distance between a trigger position of the mounting platform and an initial position of the mounting platform in the first direction in a case where the object to be printed triggers measurement of the height measuring assembly; and
control the printing assembly to print the object to be printed according to the first distance.

13. The printing device according to claim 12, wherein the controller is further configured to:
prior to controlling the mounting platform to move close to the print head in the first direction:
acquire an image of the mounting surface of the mounting platform;
identify a position of the object to be printed placed on the mounting platform according to the image of the mounting surface; and
control the mounting platform to move in a direction perpendicular to the first direction according to the position of the object to be printed, so that the object to be printed moves within a measurement range of the height measuring assembly.

14. The printing device according to claim 12, wherein the controller is further configured to control the printing assembly to print the object to be printed according to the first distance by:
determining a moving distance of the mounting platform in the first direction according to the first distance and a known second distance between a mounting position of the laser through-beam sensor of the height measuring assembly and a position of the print head in the first direction;
controlling the mounting platform to move in the first direction according to the moving distance, so that a distance between a highest point of the object to be printed and the jet of the print head is a set distance; and
controlling the printing assembly to print the object to be printed.

15. The printing device according to claim 12, wherein the controller is further configured to:
prior to controlling the mounting platform to move close to the print head in the first direction:
control the mounting platform to move to the initial position of the mounting platform in the first direction after receiving a first instruction; and
start printing after receiving a second instruction.

16. A printing method for controlling a printing device, wherein the printing device comprises:
a mounting assembly comprising a mounting platform with a mounting surface configured to mount an object to be printed, wherein the mounting surface has a mounting direction parallel to the mounting surface, and the mounting platform is operable to reciprocate in a first direction perpendicular to the mounting surface;
a printing assembly comprising a print head located at a side of the mounting platform having the mounting surface, a jet of the print head facing the mounting surface; and
a height measuring assembly comprising at least one group of laser through-beam sensors, wherein laser through beams emitted by the at least one group of laser through-beam sensors are parallel to the mounting surface;
and wherein the method comprises:
controlling the mounting platform on which the object to be printed is placed to move close to the print head in the first direction;
acquiring, via the height measuring assembly, a first distance between a trigger position of the mounting platform and an initial position of the mounting platform in the first direction in a case where the object to be printed triggers measurement of the height measuring assembly; and
controlling the printing assembly to print the object to be printed according to the first distance.

17. The printing method according to claim 16, wherein prior to controlling the mounting platform to move close to the print head in the first direction, the method further comprises:
acquiring an image of the mounting surface of the mounting platform;
identifying a position of the object to be printed placed on the mounting platform according to the image of the mounting surface; and
controlling the mounting platform to move in a direction perpendicular to the first direction according to the position of the object to be printed, so that the object to be printed moves within a measurement range of the height measuring assembly.

18. The printing method according to claim 17, wherein controlling the printing assembly to print the object to be printed according to the first distance comprises:
determining a moving distance of the mounting platform in the first direction according to the first distance and a known second distance between a mounting position of the laser through-beam sensor of the height measuring assembly and the position of the print head in the first direction;
controlling the mounting platform to move in the first direction according to the moving distance, so that a distance between a highest point of the object to be printed and the jet of the print head is a set distance; and
controlling the printing assembly to print the object to be printed.

19. The printing method according to claim 17, wherein prior to controlling the mounting platform to move close to the print head in the first direction, the method further comprises:
controlling the mounting platform to move to the initial position of the mounting platform in the first direction after receiving a first instruction; and
starting printing after receiving a second instruction.

20. A printing system comprising:
a computing device configured to send a first instruction to a printing device; and
the printing device comprising a frame, wherein the frame comprises:
a mounting assembly comprising a mounting platform with a mounting surface configured to mount an object to be printed, wherein the mounting surface has a mounting direction parallel to the mounting surface, and the mounting platform is operable to reciprocate in a first direction perpendicular to the mounting surface;
a printing assembly comprising a print head located at a side of the mounting platform having the mounting surface, a jet of the print head facing the mounting surface;
a height measuring assembly comprising at least one group of laser through-beam sensors, wherein laser through beams emitted by the at least one group of laser through-beam sensors are parallel to the mounting surface, and the at least one group of laser through-beam sensors are located at a side of the print head close to the mounting platform in the first direction; the laser through beams emitted by at least one group of the laser through-beam sensors are disposed obliquely with respect to the mounting direction; and
a controller to control the printing assembly to print the object after receiving the first instruction.
